(19) United States
(12) Patent Application Publication
(10) Pub. No.: US 2023/0357045 A1
(43) Pub. Date: Nov. 9, 2023

(54) PEROVSKITE STRUCTURE, METHOD FOR PRODUCING AND APPLICATION IN ELECTRODES AND SOLID OXIDE CELLS

(71) Applicant: Ceres Intellectual Property Company Limited, Horsham West Sussex (GB)

(72) Inventors: Dingyue HU, Liverpool Merseyside (GB); Matthew ROSSEINSKY, Liverpool Merseyside (GB); John CLARIDGE, Liverpool Merseyside (GB)

(21) Appl. No.: 18/246,469

(22) PCT Filed: Sep. 22, 2021
(86) PCT No.: PCT/GB2021/052467

§ 371 Date: Mar. 23, 2023

(30) Foreign Application Priority Data
Sep. 24, 2020 (GB) 2015136.1
Oct. 9, 2020 (GB) 2016089.1

(51) Int. Cl. C01G 41/00; H01M 4/90; C25B 11/047

(52) U.S. Cl. CPC C01G 41/006; H01M 4/9033; C25B 11/047; C01P 2002/52; C01P 2006/40; C01P 2002/34; C01P 2002/72; C01P 2006/37; C01P 2002/88

(57) ABSTRACT

Perovskite structures are disclosed comprising: a first element X which may be barium and/or a lanthanide, strontium, iron, cobalt, oxygen, magnesium and tungsten; the structure comprising a region of single perovskite and a region of double perovskite. Also disclosed are methods for forming such structures, electrodes comprising such structures and solid oxide cells using such structures.

### FIELD

The present disclosure relates to structures for use in solid oxide cells to electrodes, to solid oxide cells and to methods of forming structures. Specifically, the present invention relates to perovskite structures for use as electrodes and methods of making the same.

### BACKGROUND

A solid oxide fuel cell (SOFC) is a kind of solid oxide cell (SOC). It is an electrochemical device for the generation of electrical energy through the electrochemical oxidation of a fuel gas (usually hydrogen-based). The device is generally ceramic-based, using an oxygen-ion conducting metal-oxide derived ceramic as its electrolyte. As most ceramic oxygen ion conductors (for instance, doped zirconium oxide or doped cerium oxide) only demonstrate technologically relevant ion conductivities at temperatures in excess of 500° C. (for cerium-oxide based electrolytes) or 650° C. (for zirconium oxide based ceramics), SOFCs operate at elevated temperatures.

In common with other fuel cells, SOFCs include an anode where fuel is oxidised, and a cathode where oxygen is reduced. These electrodes must be capable of catalysing the electrochemical reactions, be stable in their respective atmospheres at the temperature of operation (reducing on the anode side, oxidising on the cathode side), and be able to conduct electrons so the electric current generated by the electrochemical reactions can be drawn away from the electrode-electrolyte interface.

Various materials have been explored for use as cathodes in SOFCs including perovskite cobalt crystals. Barium and lanthanide containing materials such as BSCF and LSCF (barium/lanthanum, strontium and iron containing cobalt oxides) are examples of such materials and perform well as SOFC cathodes due to their high oxygen ion conductivity and area specific resistance (ASR).

However, many such materials (such as conventional ‘undoped’ BSCF) suffer significantly from poor thermal and chemical stability. BSCF in particular reacts with various electrolyte materials while sintering (at 900° C. with cerium oxide based electrolytes, the most common electrolyte type with BSCF in terms of SOFC operating temperatures) and undergoes a phase transition from cubic to hexagonal polymorph at ≤900° C. (which is the typical operating temperature for the material) detrimental to its transport and catalytic properties and so increasing ASR over time, thus eliminating it from the practical use in SOFC applications.

Therefore, it is desirable to develop materials which have a comparable or lower ASR to BSCF and LSCF in low and intermediate temperature applications; yet which are more stable and, in particular, which exhibit reduced phase transition and hence have the ability to maintain lower ASR over time.

Some work has been done to augment the properties of these materials in order to improve oxygen ion conductivity, increase thermal stability and enhance resistance to degradation. For instance, heavy doping of BSCF with molybdenum has been found to improve conductivity and also improve the stability of the material whilst keeping the ASR values comparable to that of BSCF.

Unfortunately, many doped materials when used in SOFCs suffer a “leeching” phenomenon where the dopant comes out of the cathode material (e.g. to form (Ba/Sr)MoO₄) and the performance of the cathode diminishes. Further, if too much of the dopant is allowed to leech out of the cathode material, then structural rearrangements can occur within crystal structures which can cause the electrode materials to fracture and decrease performance.

Demont, A., et al., “Single Sublattice Endotaxial Phase Separation Driven by Charge Frustration in a Complex Oxide”, J. Am. Chem. Soc., 2013, 135, p. 10114-10123 discloses the use of molybdenum as a dopant material for making perovskite structures. Popov et al “improvement of Ba_{0.5}Sr_{0.5}Co_{0.8}Fe_{0.2}O_{3-δ} functional properties by partial substitution of cobalt with tungsten”, Journal of Membrane Science, 2014, 469, p. 89-94 relates to a tungsten substituted SOFC.

WO 2016/083780 A1 describes a dual phase perovskite structure used in solid oxide fuel cells, which comprises a tungsten dopant. This provides enhanced properties and resists leeching of the dopant compared to some other materials. US-A-2016/0329570 discloses perovskite structures for use as electrodes in solid oxide fuel cells (SOFCs). US-A-2010/0018394 discloses an inorganic/organic composite that may include a perovskite.

Despite these advances, it is nevertheless desirable to find materials which demonstrate enhanced properties.

### SUMMARY

There is provided in a first aspect of the present disclosure, a perovskite structure comprising: a first element X, strontium, iron, cobalt, oxygen and tungsten; wherein the first element X is barium and/or a lanthanide and wherein the structure comprises a region of single perovskite (SP) and a region of double perovskite (DP); characterized in that the perovskite structure further comprises magnesium.

### BRIEF DESCRIPTION OF THE DRAWINGS

FIG. 1 shows basic properties of BSCFW-xMg, specifically (a) XRD patterns of BSCFW-xMg (x=0, 0.05, 0.1, 0.15); (b) total conductivity; (c) thermal stability and CO₂ tolerance performance of BSCFW-0.05Mg; and (d) thermal expansion coefficient. As shown in FIG. 1b, the curves are 10 BSCFW; 20 BSCFW-0.05Mg; 30 BSCFW-0.1Mg and 40 BSCFW-0.15Mg. In FIG. 1d, the curves are 70 BSCFW; 60 BSCFW-0.05Mg; 50 BSCFW-0.1Mg and 80 BSCFW-0.15Mg.

FIGS. 2a-2e show ASR and ASR stability of BSCFW-xMg, specifically (a) ASR-T; (b) ASR and ASR decay rate at operating temperature (650° C.) as a function of x for BSCFW-xMg; (c) comparison of ASR stability of BSCF, BSCFW and BSCFW-0.05Mg, with impedance semi-circle plots before and after 7200-minute stability test at 650° C. in static air shown in (d) & (e). In FIG. 2a, the curves are 110 BSCFW; 100 BSCFW-0.05Mg; 120 BSCFW-0.1Mg; 130 BSCFW-0.15Mg; and 90 BSCFW-0.2Mg.

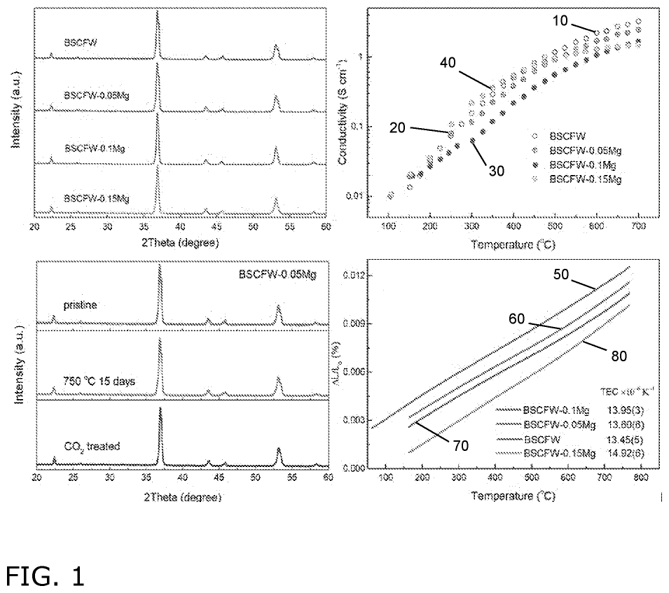

### DETAILED DESCRIPTION

The inventors have surprisingly found that tungsten containing perovskites doped with magnesium demonstrate remarkable improvements in properties over conventional SOC air electrode materials and other doped perovskite materials. In particular, the presence of magnesium appears to improve not only the ASR of the material but also greatly enhances the consistency of the ASR over time.

Without being bound by theory, it is believed that the magnesium deposits itself at the boundary between the single and double perovskites by incorporation into B site regions of the material. It is not currently clear why this would enhance the material's resistance to a drop in ASR.

The term “dopant” as used herein is not intended to be restricted to a maximum percentage of elements, ions or compounds added to chemical structures. Similarly, the term “doping” is intended to mean the addition of a certain amount of elements, ions or compounds to a material. It is not limited to a maximum quantity of material, after which, further addition of material no longer constitutes doping.

The term “perovskite structure” as used herein refers to a single network of chemically bonded crystal structures which have a generally perovskite (ABO₃) structure. This does not mean that this single network need possess a single, uniform crystal structure throughout the entire structure. However, where different crystal structures occur between different regions of the network, it is often the case that these regions have complementary structures permitting chemical bonds to more easily form there between. An example of this would be single and double perovskite crystal regions.

The term “region” as used herein with reference to the single and double perovskite regions is intended to refer to an area or portion which forms part of and is integral to the single network making up the perovskite structure. This is distinguished from areas simply being adjacent to and/or in physical contact with one another.

The term “solid oxide cell” (SOC) is intended to encompass both solid oxide fuel cells (SOFCs) and solid oxide electrolysis cells (SOECs). Typically, the present disclosure is implemented with respect to SOFCs.

The term “atomic percent” or “atomic percentage” (abbreviated herein to “at. %”) refers to the percentage of atoms with respect to a given perovskite dopant site. As one skilled in the art would appreciate, perovskites have an ABO₃ type structure. Accordingly, there are three sites capable of being doped: site A, site B and the oxygen site. By way of example, when a tungsten dopant is used to augment a BSCF perovskite, tungsten is incorporated into the B site (i.e. it replaces some of the cobalt and iron in the native B sites). A tungsten dopant concentration of 10 at. % therefore corresponds to situations wherein 10% of the B site atoms (i.e. cobalt and/or iron atoms) have been replaced with tungsten. Similarly, a magnesium dopant concentration of 3 at. % in BSCFW corresponds to situations wherein 3% of the B site atoms (i.e. cobalt, iron and/or tungsten atoms) have been replaced with magnesium.

The first element X may be a lanthanide such as lanthanum. The addition of magnesium can augment a variety of perovskite materials in order to fit a specific purpose.

It is typically the case that the first element X is barium. When barium is used, together with strontium, iron, oxygen, tungsten and cobalt, it forms a particularly effective air electrode material and is improved greatly by the presence of magnesium. The air electrode is typically a cathode.

Often, the perovskite structure according to the present invention will contain tungsten in an atomic percentage of 20 at. %-50 at. %. Doping materials such as BSCF or LSCF with quantities of dopant such as tungsten at concentrations higher than about 20 at. % can result in a mixed perovskite structure containing large quantities of both double perovskite and single perovskite. It is thought that the presence of dopants such as tungsten at said concentrations encourages endotaxial growth to occur which results in significant quantities of both single and double perovskite structures being formed.

As used herein, the term “endotaxial growth” is intended to mean that the formation of more than one complementary crystal structure, for example single and double perovskite, such that they co-exist. Typically, this refers to the propagation of two complementary crystal structures and often, this is single perovskite and double perovskite.

Perovskite structures as defined herein (having both single and double perovskite regions), such as those acquired via endotaxial growth, are advantageous because the mixture or “alloy” of regions amongst the perovskite structures improves the properties of the overall material. Without being bound by theory, it is thought that when both the double and single perovskite structures are locked together in a common perovskite structure, this allows the single perovskite to resist changes in structure due to the surrounding, interlocking double perovskite which has a more stable crystal structure.

The total concentration of tungsten may be in the range 20 at. %-50 at. %. The inventors have found this particular concentration of dopant to result in optimal perovskite structures with a good balance between stability and conductivity of the structure.

Further, it is typically the case that the concentration of magnesium is up to 20 at. % (i.e. in the range of >0 at. % to 20 at. %). More typically, magnesium is present in a range from 1 at. % to 18 at. %; even more typically, 2 at. % to 16 at. %; more typically still, 3 at. % to 14 at. %; even more typically still 4 at. % to 12 at. %; and most typically in the range of 5 at. % to 10 at. %.

The structure of the composition according to the present invention typically has the chemical formula:

(Ba₁₋ₓSrₓ)(Co_{1-y}Fe_{y})ₐW_{b}Mg_{c}O_{d}

wherein, both x and y are independently in the range 0.1 to 0.9; the sum of a, b and c is equal to 1; c is >0; and d is in the range of 2 to 3. This structure is intended to be an average chemical formula for a typical perovskite material of the present disclosure. Different regions of a typical perovskite structure will vary in composition and structure. The ratio of elements in this formula and corresponding values described, including the values of a, b and c, or the sum thereof, are not to be interpreted as exact or integer values. Defects, interstitial ions, impurities and other variations in the crystal structures occur naturally in all ionic lattices and furthermore, the perovskite structures described herein have at least a region of both single and double perovskite.

The value of “c” is >0, and may be in the range of >0 to 0.2, more suitably 0.05 to 0.2 and often 0.05 to 1.0.

The value “d” is in the range of 2 to 3, and often in the range of 2.5 to 3. Suitably, the value “d” is about 3. The intense conditions at which electrochemical systems, such as SOFCs, operate means that oxygen present in the crystal structure, as well as oxygen present in the oxidant source can act as a source of oxygen ions. Typically, oxygen travels from an area of higher partial pressure of oxygen to lower partial pressure of oxygen, such as from the oxidant side (air side) of the fuel cell to the reduction side (fuel side) of the fuel cell. Oxygen present in the perovskite material can be liberated from the ionic matrix in which it is bound and travel through the material. Accordingly, the amount of oxygen present in the perovskite structure is changeable and varies within the above ranges depending on reaction conditions and particular crystal compositions. Suitably, the value “d” is approximately equal to 3 as this has been found to provide optimal results. This variation in oxygen content is often described as “b”, for example “ABO_{3-δ}”.

It is typically the case that x may be in the range 0.2 to 0.8, or 0.3 to 0.7 or more typically still 0.4 to 0.6. In most cases, x may typically be 0.5. Further, it is usually the case that y may be in the range 0.1 to 0.8, or more typically 0.1 to 0.7 or more typically still 0.2 to 0.6 or even more typically 0.2 to 0.4. Typically, y may be 0.3.

The inventors have found that selecting these values of x and y leads to perovskite structures with an optimal balance between oxygen ion conductance and stability. As mentioned above, variation in crystal structures is common and natural. These values are not to be construed as being precise and exact. These values are all considered to be modified by the term “about”.

The ratio of single to double perovskite in the present disclosure can be varied in order to suit a specific purpose. Typically, the weight ratio of single perovskite to double perovskite may be in the range 1:9 to 9:1. More typically, the ratio of single perovskite to double perovskite is in the range, 1:5 to 5:1 and even more typically 1:1 to 1:9. Often, the ratio of single perovskite to double perovskite is 2:8. It is usually the case that more double perovskite is present than single perovskite as this improves the stability of the perovskite structure, important for many electrochemical systems, such as SOFC, which are required to run under harsh conditions for long periods of time.

Also provided in a second aspect of the present disclosure, is an electrode for an electrochemical system (such as a fuel cell) comprising the perovskite structure according to the first aspect of the present disclosure. Typically, the electrode is an air electrode (such as a cathode).

There is also provided in a third aspect of the present disclosure, an electrochemical cell (often a fuel cell) comprising the perovskite structure according to the first aspect of the present disclosure or an electrode according to the second aspect of the present disclosure. Typically, the electrochemical cell is a solid oxide cell, such as a SOFC.

There is also provided in a fourth aspect of the present disclosure a cell stack comprising one or more of the solid oxide cells according to the third aspect of the present disclosure, typically this is a solid oxide fuel cell stack.

Further, the present disclosure also provides in a fifth aspect of the present disclosure a method of forming a perovskite structure according to the first aspect of the present disclosure, comprising: mixing starting materials to form a mixture, wherein the starting materials comprise a first element X, strontium, iron, cobalt, oxygen, magnesium and tungsten; heating the mixture to a first temperature for a first period of time to form a single perovskite; and heating the mixture to a second temperature for a second period of time to form a double perovskite; wherein the first element X is barium and/or a lanthanide such as lanthanum.

Reference to elements such as barium, lanthanum, strontium, iron, cobalt, oxygen, magnesium and tungsten as used herein is intended to refer to a material which comprises said element. This could be elemental (e.g. pure tungsten) or could be a compound comprising a range of elements including one or more of those elements described herein (e.g. Co₃O₄ or CO₂). The elements are typically provided as oxides as these are among the most common and stable forms in which the elements naturally occur. Often, the magnesium is provided as magnesium oxide (MgO).

The inventors have found that when tungsten is used in the above method, this generates a perovskite structure wherein nearly all the tungsten is incorporated into double perovskite regions. This appears to result in a particularly stable and conductive material.

In particular, the inventors have found that employing tungsten as a dopant leads to perovskite structures having a low oxygen content (high oxygen vacancy).

Typically, the first element X is barium. Those materials generated by the method using barium have been found to be particularly effective in electrochemical cells, such as SOFCs.

It is often the case that the method of the present disclosure, further comprises a comminuting step prior to the heating steps. It is advantageous to reduce the starting materials to a fine particulate form so that the starting materials can be blended into a homogeneous mixture with a high surface area. This results in a more uniform perovskite structure when heated.

Whilst a variety of different comminuting methods and techniques exist, a method often used for comminuting the starting materials is ball milling. The inventors found that ball milling provides a quick and efficient method of breaking up and reducing the size of the starting materials.

After the starting materials have been comminuted, it is often the case that the comminuted starting materials are pressed to increase the compact form density prior to the heating steps. This is advantageous as it ensures air is squeezed out of any gaps in the blended mixture and improves the contact between particles. This helps to ensure that the resulting perovskite structure is free from defects, cracks and other areas of weakness. Usually, the mixture of comminuted starting materials are compressed into pellets. This pressing step can be repeated at multiple stages throughout the synthetic process. Typically, it is done prior to the sintering step three i.e. after the first and second steps have been performed. Whilst the pressing is usually only performed once, the pressing process could be conducted numerous times and before each step of the process.

The first temperature and the second temperature to which the starting materials are heated are sufficient to bring about formation of single perovskite and double perovskite respectively. The absolute temperatures at which these formations occur is dependent upon the ratio of starting materials and the particular dopants and additives that have been included in the starting material. The skilled person will be familiar with crystal classification techniques such as x-ray diffraction, neutron scattering experiments and spectroscopic techniques such as Mossbauer spectroscopy and can determine whether or not a given perovskite structure has been formed.

Typically, the first temperature is in the range 600° C.-800° C., more typically in the range 650° C.-750° C., and even more typically is approximately 700° C. These temperatures have been found by the inventors to be most effective at promoting the formation of single perovskite and which result in little to no formation of double perovskite.

Further, the second temperature is typically in the range 800° C.-1100° C., more typically in the range 850° C.-1000° C. and even more typically is approximately 900° C. These temperatures have been found by the inventors to be most effective at promoting the formation of double perovskite.

Often, the first period of time at which the starting materials are exposed to the first temperature is greater than 20 minutes, more typically greater than 1 hour. Often, the first temperature will be held for a time in the range 4 to 8 hours. The second period of time is typically greater than 20 minutes, more typically greater than 1 hour. Often, the second period of time will be in the range 1 to 10 hours and typically 6 to 10 hours.

Although not essential, the method may further comprise a sintering step at a third temperature in air for a third period of time after the second heating step. The inventors have found that this brings about an improvement in the properties of the resulting perovskite material. Specifically, a further sintering step was found by the inventors to improve the degree of crystallinity and parity of the SP/DP perovskite structure. This high crystallinity improves the stability and oxide ion conducting properties.

Typically, the third temperature is in the range 900° C.-1300° C.; more typically, in the range 1100° C.-1300° C.; even more typically 1200° C.-1250° C. and even more typically is approximately 1250° C. If the temperature is increased much above 1300° C. it is possible for the perovskite, or components of the composition to melt. Further, the third period of time over which the sintering step occurs is typically at least 20 minutes and more typically at least 1 hour. Often, the third period of time will be in the range 1 to 12 hours and, in particular, may be 8 to 12 hours.

The inventors have found that if the starting materials are heated to very high temperatures over a period of time shorter than these periods, the resulting perovskite structure often include defects. Therefore, it is desirable to have a minimum period of time for each heating step as described, in order to allow gradual formation of the perovskite structure. There is no real disadvantage to exposing the starting materials to the heating conditions for longer periods but this does not usually bring about any great improvement in properties and it is costly to maintain high temperature conditions for almost negligible improvements in properties. The time period is also dependent to some extent on the specific temperatures used in the method. Therefore, these time periods represent a typical compromise to arrive at an optimal perovskite structure.

Furthermore, it may be the case that the method is repeated at least once. By this it is meant that once the perovskite structure has been formed, this product then is used as at least part of the starting material for the repetition and the same method is applied again. This improves the properties and homogeneity of the end perovskite structure. There is no limitation on the number of times the method can be repeated in this fashion, however it is typically 3 or 4 times. Repeating the process more than this seems to provide only incremental or negligible improvements in properties.

Unless otherwise stated each of the integers described in the present disclosure may be used in combination with any other integer as would be understood by the person skilled in the art. Further, although all aspects of the present disclosure preferably “comprise” the features described in relation to that aspect, it is specifically envisaged that they may “consist” or “consist essentially” of those features outlined in the claims.

The present disclosure will now be described with reference to accompanying figures and examples.

### EXAMPLES

### Example 1—Synthesis of BSCFW-xMg

Ba_{0.5}Sr_{0.5}(Co_{0.7}Fe_{0.3})_{0.69-x}MgₓW_{0.31}O_{3-δ} (x=0, 0.02, 0.03, 0.04, 0.05, 0.06, 0.07, 0.08, 0.1, 0.15, 0.2, 0.3 abbreviated as BSCFW-xMg) were prepared by via a solid state reaction route. Stoichiometric amounts of BaCO₃ (99.995%), SrCO₃ (99.994%), C0304 (99.7%), Fe₂O₃ (99.99%), WO₃ (99.9%) and MgO (99.95%) were dried at 200° C. and weighed. The raw materials were ball milled using ZrO₂ milling media (10 mm balls) and iso-propanol at 350 r.p.m. for 12 hours. The milled mixtures were dried and calcined at 700° C. for 6 h followed by 900° C. for 8 h with heating and cooling rate both of 5° C./min. The calcined powders were milled further using the same condition as the first ball milling, the powders were pressed into 10 mm diameter pellets and sintered at 1200-1250° C. for 12 h using 5° C./min both heating and cooling rates.

### Example 2—Fabrication of Symmetrical Cells and ASR Measurement

Samarium doped ceria (abbreviated as ‘SDC’) were chosen as the electrolyte material for symmetrical BSCFW-xMg cells. SDC powders were pressed into 10-mm pellets and sintered at 1400° C. for 14 hours under air. The BSCFW-xMg inks were prepared by mixing BSCFW-xMg powder and binder (V-600, Heraeus) with the weight ratio 1:0.7 and the mixture was ball milled for 3 h. BSCFW-xMg ink was then screen-printed 6 times on both sides of the SDC pellet. The cells were fired at 950° C. in air for 1 h with heating and cooling rates of 1.8° C./min and 3° C./min respectively. Gold paste was applied to both sides of the pellet over the annealed ink before further firing at 600° C. in air for 1 h. BSCFW-xMg symmetrical cells were performed for ASR measurements with applied 10 mV A.C. voltage over a frequency range of 0.01 Hz to 1 MHz.

### Example 3—Comparison Between BSCFW and BSCFW-xMg

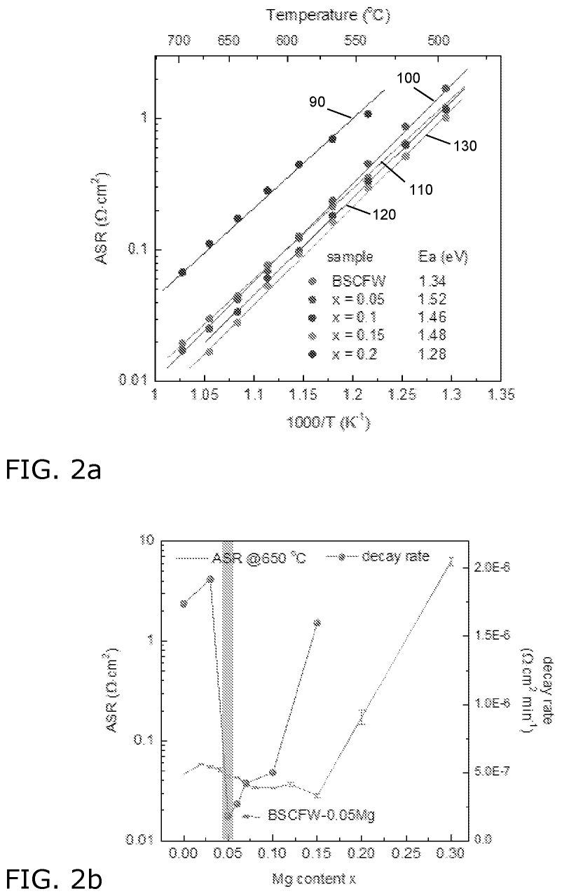

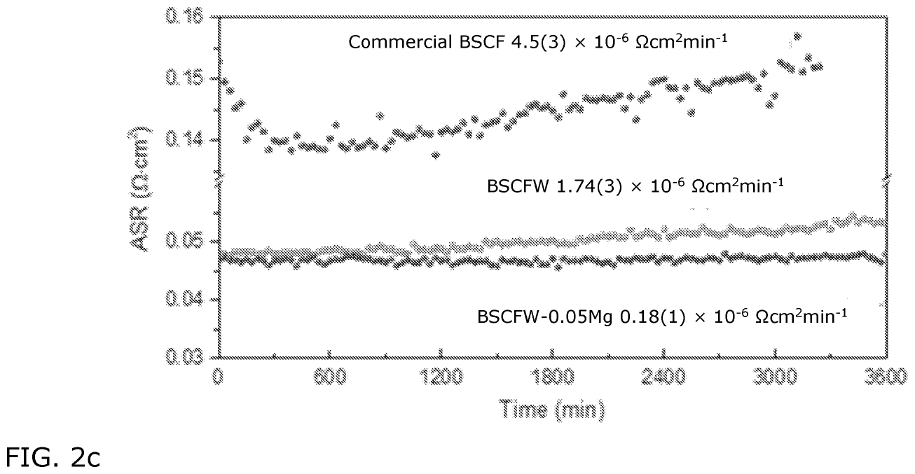

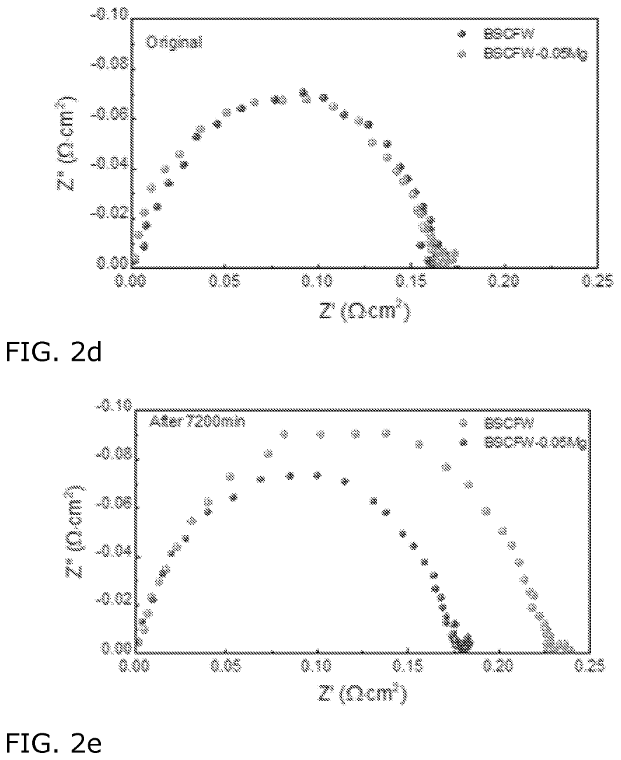

The area specific resistance (ASR) and ASR stability of the BSCFW-xMg cathode were measured by symmetrical cathode/electrolyte (samarium doped ceria)/cathode cells, and the data are shown in FIGS. 2a-2e. FIG. 2(a) displays the ASR versus inverse temperature for BSCFW-xMg (x=0, 0.05, 0.1, 0.15, 0.2). For x 50.1 BSCFW-xMg, the ASR values are similar to undoped BSCFW over the temperature range 500° C. to 700° C. The activation energy, calculated from linear fitting in FIG. 2(a), increased from 1.34 eV (BSCFW) to 1.52 eV (BSCFW-0.05Mg), then decreased to 1.46 eV (BSCFW-0.1 Mg).

The ASR at typical SOFC operating temperature (650° C.) for different BSCFW-xMg compositions (0≤x≤0.15) are plotted in FIG. 2(b). 2 at % Mg doping slightly increases the ASR to 0.0584(8) Ω·cm², with lower ASR values for further Mg doped compositions, reaching 0.028(3) Ω·cm² for BSCFW-0.15Mg. The lowest ASR decay rate is observed for 5% Mg doping but the ASR decay rate increases upon adding more Mg, and the result of BSCFW-0.15Mg (1.6(1)×10−6 Ω·cm² min⁻¹) is close to undoped BSCFW.

FIG. 2(c) shows the evolution of ASR over time for BSCFW, BSCFW-0.05Mg and commercial BSCF cells. All cells were held at 650° C. for 3600 min; the initial ASR for BSCFW-0.05Mg is 0.0468(2) Ω·cm², slightly lower than BSCFW (0.0480(1) Ω·cm²) however its ASR decay rate over the 60 hr is much lower, 0.18(1)×10−6 Ω·cm² min⁻¹ which is equivalent to approx. 10% of BSCFW (1.74(3)×10−6 Ω·cm² min⁻¹) and 4% of commercial BSCF.

FIGS. 2(d) and 2(e) show direct comparison of the impedance arc plot of BSCFW and BSCFW-0.05Mg before and after 7200 min aging test at 650° C. The Nyquist spectrum data were plotted with the high frequency (10 MHz) intercepts set to zero to display the change in the polarization responses more clearly. The ASR value of BSCFW-0.05Mg after the 7200 min test is 0.0488(4) Ω·cm² compared to BSCFW which is 0.0632(1) Ω·cm², indicating the ASR decay has been suppressed almost entirely by Mg doping.

The measurement cells were assessed post-measurement via SEM. Cross-sectional images of BSCFW-0.05Mg cells show that the aged cell appears identical to the unaged one with no signs of connection issues including obvious interfacial chemical reaction, melting or delamination between electrolyte and cathode.

All publications mentioned in the above specification are herein incorporated by reference. Although illustrative embodiments of the present disclosure have been disclosed in detail herein, with reference to the accompanying drawings, it is understood that the present disclosure is not limited to the precise embodiment and that various changes and modifications can be provided therein by one skilled in the art without departing from the scope of the present disclosure as defined by the appended claims and their equivalents. The disclosures of the published documents referred to herein are incorporated by reference in their entirety.

This application claims the priority of GB2016089.1 filed on 9 Oct. 2020 and GB2015136.1 filed on 24 Sep. 2020: the entire contents of both documents are hereby incorporated by reference.

1. A perovskite structure comprising:
a first element X, strontium, iron, cobalt, oxygen, and tungsten;
wherein the first element X is barium and/or a lanthanide;
wherein the structure comprises a region of single perovskite and a region of double perovskite; and
wherein the perovskite further comprises magnesium.

2. The perovskite structure according to claim 1, wherein the concentration of tungsten is in the range of 20-50 at. %.

3. The perovskite structure according to claim 1, wherein the concentration of magnesium is up to 20 at. %.

4. The perovskite structure according to claim 1, wherein the concentration of magnesium is in the range 1 at. % to 18 at. %.

5. The perovskite structure according to claim 1, wherein the concentration of magnesium is in the range 3 at. % to 14 at. %.

6. The perovskite structure according to claim 1, wherein the concentration of magnesium is in the range 5 at. % to 10 at. %.

7. The perovskite structure according to claim 1, wherein the lanthanide is lanthanum.

8. The perovskite structure according to claim 1, wherein element X is barium.

9. The perovskite structure according to claim 1, wherein the perovskite has a formula according to formula (1):
(Ba₁₋ₓSrₓ)(Co_{1-y}Fe_{y})ₐW_{b}Mg_{c}O_{d} (I)
wherein
x and y are each independently in the range 0.1 to 0.9;
the sum of a, b and c is equal to 1;
c is >0; and
d is in the range of 2 to 3.

10. The perovskite structure according to claim 9, wherein c is in the range 0.05 to 0.2.

11. An electrode comprising the perovskite structure according to claim 1.

12. The electrode according to claim 11, wherein the electrode is an air electrode.

13. A solid oxide cell comprising the perovskite structure according to claim 1.

14. The solid oxide cell according to claim 13, wherein the solid oxide cell is a solid oxide fuel cell or a solid oxide electrolysis cell.

15. A method of forming a perovskite structure according to claim 1, comprising the steps of:
mixing starting materials, wherein the starting materials comprise: a first element X, strontium, iron, cobalt, oxygen, tungsten, and magnesium to form a mixture;
heating the mixture to a first temperature for a first period of time to form a single perovskite; and
heating the mixture to a second temperature for a second period of time to form a double perovskite;
wherein the first element X is barium and/or a lanthanide.

16. The method according to claim 15, further comprising a comminuting step prior to the heating steps.

17. The method according to claim 15, wherein the first temperature is in the range 650° C.-750° C.

18. The method according to claim 15, wherein the second temperature is in the range 850° C.-1000° C.

19. The method according to claim 15, wherein the first period of time is in the range 4 to 8 hours.

20. The method according to claim 15, wherein the second period of time is in the range 6 to 10 hours.

21-23. (canceled)

24. The method according to claim 15, wherein the method is repeated at least once.
